(19) United States
(12) Patent Application Publication
(10) Pub. No.: US 2010/0078929 A1
(43) Pub. Date: Apr. 1, 2010

(54) REFILLABLE AND REUSABLE PAD

(75) Inventor: Curtis Patrick TAYLOR, Chagrin Falls, OH (US)

Correspondence Address: PILLSBURY WINTHROP SHAW PITTMAN, LLP, P.O. BOX 10500, MCLEAN, VA, 22102, US

(73) Assignee: IDEASTREAM CONSUMER PRODUCTS, LLC, Cleveland, OH (US)

(21) Appl. No.: 12/567,593

(22) Filed: Sep. 25, 2009

Related U.S. Application Data
(60) Provisional application No. 61/100,412, filed on Sep. 26, 2008.

(51) Int. Cl. B42F 3/00

(52) U.S. Cl. 281/45

(57) ABSTRACT

An apparatus for supporting a pad of paper comprising a plurality of sheets joined together at a joined edge portion, the joined edge portion having at least one hole therethrough is disclosed. In some aspect of the invention, the apparatus comprises a substantially rigid support member configured to support the pad of paper, the support member including a front surface; a receiving member provided at an edge portion of the support member, the receiving member providing an opening extending across the front surface of the support member and configured to receive the joined edge portion of the pad of paper being engaged with the front surface; and at least one fastener member provided at the edge portion of the support member and projecting forwardly therefrom, the at least one fastener member being spaced from the opening of the receiving member and being configured to be received in the at least one hole in the joined edge portion of the pad of paper being engaged with the front surface of the support member so as to removably secure the pad of paper to the support member in cooperation with the receiving member.

### CROSS-REFERENCE TO RELATED APPLICATION

This application claims priority and benefit under 35 U.S.C. §119(e) to U.S. Provisional Patent Application No. 61/110,412, entitled “Refillable and Reusable Pad”, filed on Sep. 26, 2008. The content of that application is incorporated herein in its entirety by reference.

### FIELD

The present invention relates generally to an apparatus for supporting a pad of paper, and more particularly, to securing the pad of paper to a support member that can be refilled and reused.

### BACKGROUND

Notepads are often sold with a cardboard backer that is used to provide a supportive surface to write upon. These cardboard backers are usually heavy and thick and constitute considerable waste when the notepad is deposed. Often times, this cardboard backer is the only part of the notepad that is thrown away when all the sheets of the notepad have been used. Moreover, because of the nature of the cardboard of the backer, if the cardboard gets wet, then the entire notepad may get wet and shrivel and may need to be thrown away.

Spring-loaded clipboards are also known to provide a supportive surface to write upon. These clipboards allow refilling of paper by actuating a spring to release a clip, and once the paper is positioned on the clipboard, the spring is released. The spring-releasable clip is usually bulky and often does not adequately secure the paper to the supportive surface. Thus, the paper tends to skew on the supportive surface making holding the chipboard and writing thereon difficult.

### SUMMARY

In accordance with an aspect of the invention, an apparatus for supporting a pad of paper comprising a plurality of sheets joined together at a joined edge portion, the joined edge portion having at least one hole therethrough is disclosed. The apparatus comprises a substantially rigid support member configured to support the pad of paper, the support member including a front surface; a receiving member provided at an edge portion of the support member, the receiving member providing an opening extending across the front surface of the support member and configured to receive the joined edge portion of the pad of paper being engaged with the front surface; and at least one fastener member provided at the edge portion of the support member and projecting forwardly therefrom, the at least one fastener member being spaced from the opening of the receiving member and being configured to be received in the at least one hole in the joined edge portion of the pad of paper being engaged with the front surface of the support member so as to removably secure the pad of paper to the support member in cooperation with the receiving member.

In accordance with an aspect of the invention, an apparatus for supporting a pad of paper comprising a plurality of sheets joined together at a joined edge portion, the joined edge portion having at least one hole therethrough is disclosed. The apparatus comprises a substantially rigid support member configured to support the pad of paper, the support member including a front surface; a receiving member provided at an edge portion of the support member, the receiving member providing an opening extending across the front surface of the support member and configured to receive the joined edge portion of the pad of paper being engaged with the front surface; and at least one fastener member provided at the edge portion of the support member and projecting forwardly therefrom, each fastener comprising a post portion and at least one retaining projection configured and arranged to engage peripheral portions of the paper proximate the holes during motion in a direction away from the front surface and to allow the holes to pass over the projection during motion in a direction towards the front surface so as to removably secure the pad of paper to the support member in cooperation with the receiving member.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various Figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 shows a front view of an apparatus for supporting a sheet of paper in accordance with an aspect of the invention.

FIG. 2 shows a back view of the apparatus of FIG. 1.

FIG. 3 shows a side view of the apparatus of FIG. 1.

FIG. 4 shows a close-up of a fastener member of FIG. 3.

FIG. 5 shows a side view of a fastener member in accordance with another aspect of the invention.

FIG. 6 shows a front view of the apparatus of FIG. 1 with a pad of paper received therein.

### DETAILED DESCRIPTION

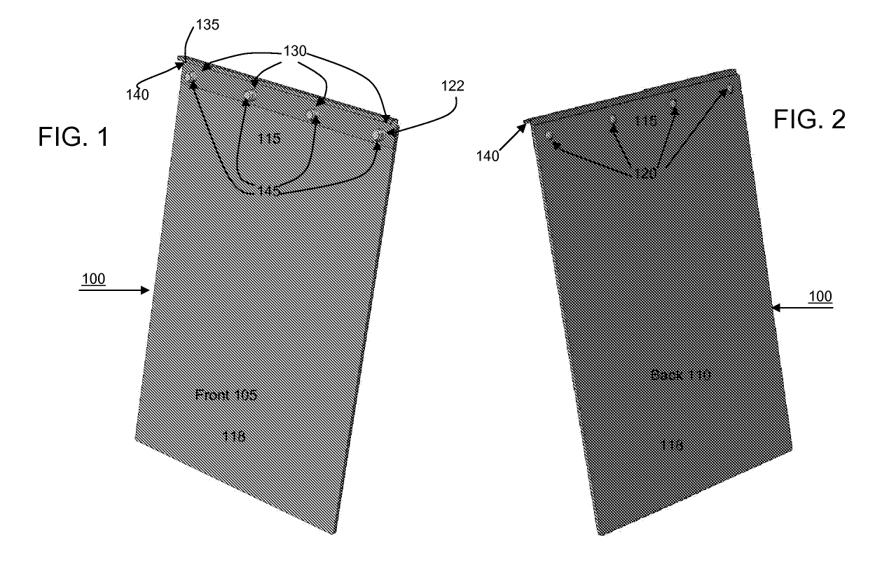

FIG. 1 shows a front view and FIG. 2 shows a back view of an apparatus for supporting a pad of paper in accordance with an aspect of the invention. The term “pad of paper” refers to a plurality of sheets of paper joined together at one end, such as by adhesive or other suitable means, wherein sheets of paper can be removed individually. Typically, the pad has an edge portion where the sheets are joined together, and each sheet is perforated or otherwise weaken along the edge portion so the sheet can easily be torn from the edge portion with a neat, clean appearance. Such features are commonplace on conventional pads of paper with a cardboard backing.

The support member for supporting the pad of paper, generally indicated by 100, includes a planar front surface 105, a planar back surface 110, a top end 115 and a bottom end 118. The support member is substantially rigid. By way of non-limiting examples, the appropriate materials can be thermoplastic elastomers, commonly referred to as TPE or thermoplastic rubbers. Other material can be used such as metal including aluminum, cardboard and engineered wood products as appropriate so long as the material provides a substantially rigid surface to write upon. In some aspect of the invention, the support member 100 can be composed of a waterproof or water-resistant material. In some aspect of the invention, the support member 100 can be composed of a material that does allow a degree of flexibility, while still providing a supportive surface on which to write. The top end 115 of the support member 100 includes one or more holes 120. Sheets of the pad of paper 125 have a standard size including 8½×11 inches, A4, 8½×14 inches. The support member 100 should match the size of the pad of paper 125. The composition of the sheets of paper include any standard paper designed to be written upon, including traditional fibrous paper and any other material.

At the top end 115 of the support member 100, and affixed to the front surface 105, is a receiving member 122 configured to enclose at least a portion of one end of a pad of paper 125. The member 122 includes one or more holes 130 that correspond to holes 120 and a substantially u-shaped enclosure 135 with a wall extending forwardly from a side wall and a well extending from the forwardly extending wall and substantially parallel to the side wall. Other shaped enclosures can be used. An open end 140 is arranged such that the pad of paper 125 is secured to the front surface 105 of the support member 100 and in which one end of the pad of paper 125 can be enclosed therein to provide a securing function. Preferably, the member is substantially rigid and relatively immovable. This is, the member 122 does not pivot between an open position for receiving paper and a closed position for securing the paper. The member 122 can be composed of a different material or the same material from the support member 100. By way of a non-limiting example, the member 120 is metal; however, other material may be used as appropriate. Alternatively, the member 122 may be affixed to the back surface 110 in addition to or instead of the front surface 105, or it may be so formed integrally and continuously as one-piece with the support member 100. Thus, the illustrated configuration is not intended to be limiting.

One or more fastener members 145 are attached at the top end 115 of the support member 100 and are configured to securely fasten the pad of paper 125 to the front surface 105 of the apparatus 100. The fastener members 145 are arranged below the substantially u-shaped enclosure 135 on the front surface 105 of the support member 100 such that the wall of the u-shaped enclosure 135 does not overlap the fastener members 145. That is, the free end of the wall is spaced from the fasteners 145 so the pad edge portion can be inserted into the u-shaped member 135.

The fastener members 145 each includes a shaft 150 having a first end 152 and a second end 160, wherein the first end 152 extends out of the front surface 105 and through holes 120 and 130. In some embodiments, the shaft 150 includes outwardly extending projections 165 that have a forward facing side 170 that extends away from the first end 152 and towards the second end 160 and a backward facing side 175 that is substantially perpendicular to the shaft 150 of the fastener members 145 in a longitudinal direction. As can be seen in the Figures, these projections 165 have a frustroconical configuration flaring outwardly in the rearward direction. The fastener members 145 are configured such that they easily pass through one or more holes 180 of the paper 125 in one direction to load paper onto the support member 100 and less easily removed in the opposite direction due to the substantially perpendicular arrangement of the backward facing side. The second end 160 is a head configured to engage the back surface 110 of the support member 100.

In some embodiments, the fastener member includes a retaining projection that is wider on a support member side thereof than on a retaining member side thereof. In some embodiments, the retaining projection includes a pawl. Other types of fastener member can be use that do not have a outwardly extending projection. In this example, the fastener member can be a post with a scored surface having a friction-bearing surface. The fasteners can also be a friction-type, pressed-fit, or interference-type fasteners. By way of a non-limiting example, the fastener members 145 can be composed of a material such a polypropylene; however, other material can be used as necessary or desired. In other embodiments, the fastener members could be integrally formed and continuous as one-piece with the support member 100 and/or member 122. Thus, the illustrated configuration is not intended to be limiting.

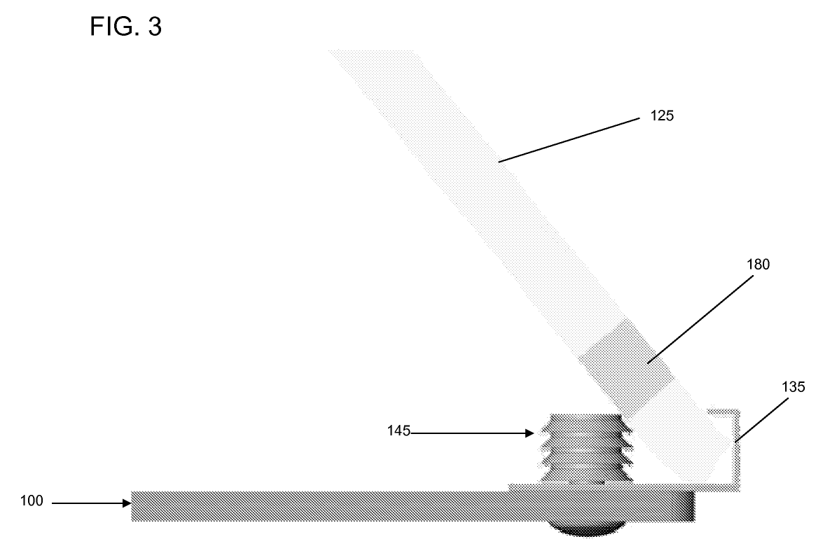

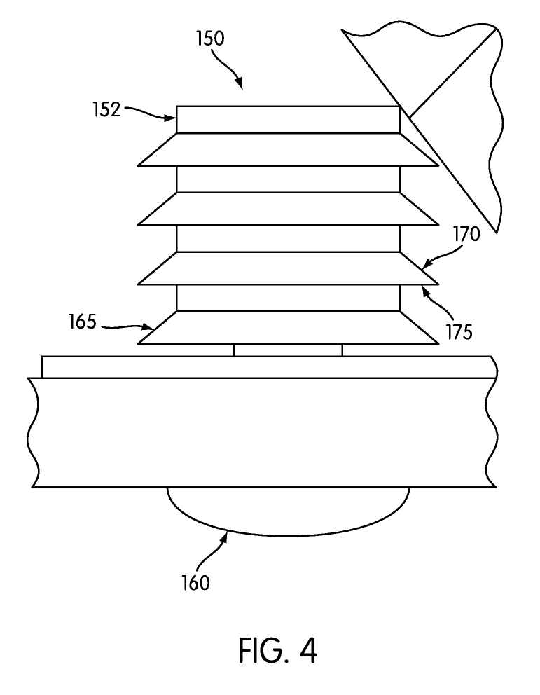

FIG. 3 shows a side view of the apparatus, and in particular, the operation of the substantially u-shaped enclosure 135 and the fastener members 145 in securing the sheets of paper 125 and FIG. 4 shows a close-up of a fastener member of FIG. 3 in accordance with an aspect of the invention. The pad of paper 125 is loaded onto the support member 100 by positioning one or more holes 180 formed in the joined edge portion of the pad 125 onto the first end 152 of the fastener members 145 and over the outwardly extending projections 165. The positioning is accomplished by placing the end of the sheets of paper 125 into the open end 140 of the substantially u-shaped enclosure 135, as shown in FIG. 3. Once the paper 125 is placed in the open end 140 of the substantially u-shaped enclosure 135, the paper is down onto the front surface 105 of the support member 100 (i.e., by pivoting), such that the holes 180 are received over the fasteners members 145 and the pad of paper 125 is secured by the outwardly extending projections 165. This completes the paper loading procedure.

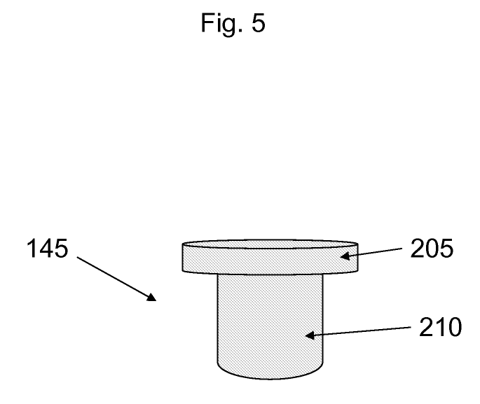

FIG. 5 shows a side view of the fastener member 145 in accordance with another aspect of the invention. In this aspect, the fastener members 145 includes a substantially smooth shaft 210 and a top portion 205 formed at an end of the substantially smooth shaft 210. The fastener member 145 is arranged to allow the at least one hole of the plurality of sheets to be positioned over the top portion 205 onto the substantially smooth shaft 210. The top portion 205 is arranged to be dimensioned slightly larger than the smooth shaft 210. Thus, once the sheets of paper are secured onto the fastener member 145, the dimension of the top portion 205 prevents the sheets from being easily removed from the fastener member 145.

The pad of paper 125 is now supported by the support member, which provides firm support like a conventional prior art cardboard backer. Thus, the pad of paper 125 can be sold without the wasteful cardboard backer, which needs to be discarded or recycled after use. Once the pad of paper 125 is used up, only the joined edge portion needs to be removed from the support member and discarded. The support member 100 can be re-used by re-loading it with another pad of paper 125.

It is envisioned that the use of the support member 100 can be used to save the costs and waste associated with the prior art cardboard backers. In particular, in settings where large amounts of pads of paper are used, such as business office environments, the support member 100 can be re-used each time a pad of paper is used up, thus greatly reducing the need for providing cardboard backers on the paper pads.

In the illustrated configuration, because of the low profile of the receiving member 122, the pads of paper 125 can be stacked nearly one atop the other in storage, just as is the case with traditional cardboard-backed pads. This facilitates the use of the support members 100, as the paper pads can be stored in a traditional stacked manner while in the support members 100.

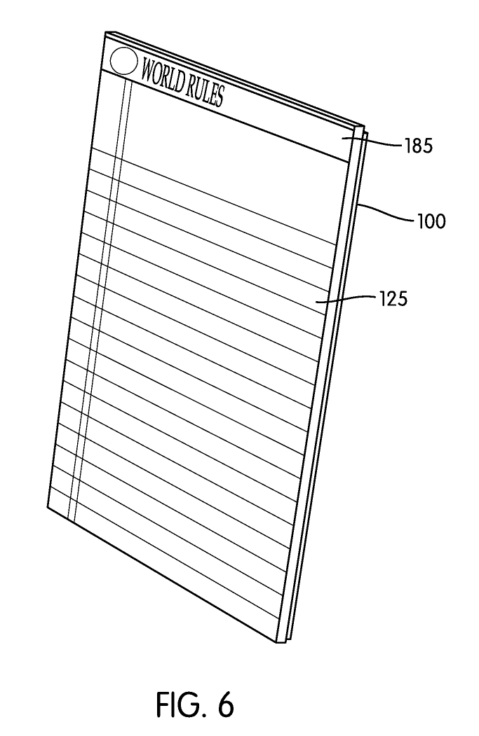

FIG. 6 shows a front view of the apparatus with an optional border in accordance with an aspect of the invention. A border 185 can be affixed to the top edge portion of the sheets of paper 125 to cover the this top edge portion and its holes. The border 185 is also arranged over top of the fastener members 145 supported by the support member 100. The border 185 can have a company logo, or any other information printed thereon.

Although the invention has been described in detail for the purpose of illustration based on what is currently considered to be a variety of useful embodiments, it is to be understood that such detail is solely for that purpose and that the invention is not limited to the disclosed embodiments, but, on the contrary, is intended to cover modifications and equivalent arrangements that are within the spirit and scope of the appended claims.

We claim:

1. An apparatus for supporting a pad of paper comprising a plurality of sheets joined together at a joined edge portion, the joined edge portion having at least one hole therethrough, the apparatus comprising:
a substantially rigid support member configured to support the pad of paper, the support member including a front surface;
a receiving member provided at an edge portion of the support member, the receiving member providing an opening extending across the front surface of the support member and configured to receive the joined edge portion of the pad of paper being engaged with the front surface; and
at least one fastener member provided at the edge portion of the support member and projecting forwardly therefrom, the at least one fastener member being spaced from the opening of the receiving member and being configured to be received in the at least one hole in the joined edge portion of the pad of paper being engaged with the front surface of the support member so as to removably secure the pad of paper to the support member in cooperation with the receiving member.

2. An apparatus according to claim 1, wherein an outwardly extending projection of the at least one fastener member includes a forward facing side that extends away from the first end of the fastener member and towards the second end and a backward facing side that is substantially perpendicular to a shaft of the fastener member in a longitudinal direction.

3. An apparatus according to claim 1, wherein the receiving member includes a substantially u-shaped member is composed of a first material type and the support member is composed of a second material type different from the first.

4. An apparatus according to claim 3, wherein the first type of material includes metal.

5. An apparatus according to claim 3, wherein the second type of material includes foam, aluminum, cardboard, or engineered wood.

6. An apparatus according to claim 1, wherein the at least one fastener member is composed of a polypropylene.

7. An apparatus according to claim 1, wherein a border is attached to a top surface of the sheet of paper and overtop of the fastener member.

8. An apparatus according to claim 1, wherein the at least one fastener member is configured in a frustroconical configuration.

9. An apparatus according to claim 1, wherein the support member includes a material that is substantially waterproof or water-resistant.

10. An apparatus according to claim 1, wherein the at least one fastener member includes a substantially smooth shaft and a top portion formed at an end of the substantially smooth shaft, the at least one fastener member arranged to allow the at least one hole of the plurality of sheets to be positioned over the top portion onto the substantially smooth shaft.

11. An apparatus for supporting a pad of paper comprising a plurality of sheets joined together at a joined edge portion, the joined edge portion having at least one hole therethrough, the apparatus comprising:
a substantially rigid support member configured to support the pad of paper, the support member including a front surface;
a receiving member provided at an edge portion of the support member, the receiving member providing an opening extending across the front surface of the support member and configured to receive the joined edge portion of the pad of paper being engaged with the front surface; and
at least one fastener member provided at the edge portion of the support member and projecting forwardly therefrom, each fastener comprising a post portion and at least one retaining projection configured and arranged to engage peripheral portions of the paper proximate the holes during motion in a direction away from the front surface and to allow the holes to pass over the projection during motion in a direction towards the front surface so as to removably secure the pad of paper to the support member in cooperation with the receiving member.

12. An apparatus as in claim 11, wherein each retaining projection is wider on a support member side thereof than on a retaining member side thereof

13. An apparatus as in claim 11, wherein each retaining projection comprises a pawl.

14. An apparatus as in claim 11, wherein the support member includes a material that is substantially waterproof or water-resistant.
